(19) United States
(12) Patent Application Publication
(10) Pub. No.: US 2021/0065921 A1
(43) Pub. Date: Mar. 4, 2021

(54) NUCLEAR REACTOR AND OPERATION METHOD FOR NUCLEAR REACTOR

(71) Applicants: KABUSHIKI KAISHA TOSHIBA, Minato-ku (JP); TOSHIBA ENERGY SYSTEMS & SOLUTIONS CORPORATION, Kawasaki-shi (JP)

(72) Inventors: Rei KIMURA, Setagaya (JP); Kazuhito ASANO, Ota (JP)

(73) Assignees: KABUSHIKI KAISHA TOSHIBA, Minato-ku (JP); TOSHIBA ENERGY SYSTEMS & SOLUTIONS CORPORATION, Kawasaki-shi (JP)

(21) Appl. No.: 16/992,250

(22) Filed: Aug. 13, 2020

(30) Foreign Application Priority Data
Aug. 29, 2019 (JP) 2019-156856

(51) Int. Cl. G21C 5/12; G21C 3/52; G21C 7/26; G21C 15/247

(52) U.S. Cl. CPC G21C 5/12; G21C 15/247; G21C 7/26; G21C 3/52

(57) ABSTRACT

A nuclear reactor comprising: a moderator including a metal hydride; and a nuclear fuel in which europium is added as an additive to a main nuclear fuel material. Thus, the nuclear reactor can be kept in the subcritical state even under the state where all the control devices are pulled out before startup.

### CROSS-REFERENCE TO RELATED APPLICATION

This application is based upon and claims the benefit of priority from Japanese Patent Application No. 2019-156856, filed on Aug. 29, 2019, the entire contents of which are incorporated herein by reference.

### FIELD

Embodiments of the present invention relate to a nuclear reactor and its operation method.

### BACKGROUND

The present inventors have been working on development of a calcium-hydride-moderated heat-pipe cooled reactor as a very small modular reactor (vSMR). This nuclear reactor is configured as a transportable system, assuming that it will be used as distributed energy in various places.

In order to ensure nuclear security, transportation, installation, and operation of the reactor are performed under the state in which the nuclear fuel is inside the reactor to prevent the phase of handling only the nuclear fuel. At this time, ensuring criticality safety during transportation is an important issue. In particular, in order to ensure the criticality safety during transportation, it is desirable to have a characteristic that the reactor core is kept in a subcritical state even under the state in which all the control devices (for example, control rods) are pulled out.

In view of the above-described circumstances, embodiments of the present invention aim to provide reactor-related technology that allows a nuclear reactor to remain in the subcritical state even under the state in which all the control devices are pulled out before startup.

### BRIEF DESCRIPTION OF THE DRAWINGS

In the accompanying drawings:

FIG. 1 is a longitudinal cross-sectional view illustrating a nuclear power generation system of the present embodiment;

FIG. 2 is a longitudinal cross-sectional view illustrating a nuclear reactor;

FIG. 3 is a horizontal cross-sectional view illustrating the nuclear reactor;

FIG. 4 is an enlarged horizontal cross-sectional view illustrating the nuclear reactor;

FIG. 5 is a graph illustrating a temperature-dependent effective core multiplication factor when Eu is not added;

FIG. 6 is a graph illustrating a spectrum shift with increasing temperature;

FIG. 7 is a graph illustrating the temperature-dependent effective core multiplication factor when Eu is added;

FIG. 8 is a flowchart illustrating an operation method for the nuclear reactor;

FIG. 9 is a side view illustrating an induction heater of the first modification;

FIG. 10 is an enlarged horizontal cross-sectional view illustrating the nuclear reactor of the second modification;

FIG. 11 is a longitudinal cross-sectional view illustrating the nuclear reactor of the third modification; and

FIG. 12 is a graph illustrating the temperature-dependent effective core multiplication factor of the fourth modification.

### DETAILED DESCRIPTION

In one embodiment of the present invention, a nuclear reactor comprising: a moderator including a metal hydride; and a nuclear fuel in which europium is added as an additive to a main nuclear fuel material.

Hereinafter, embodiments of a nuclear reactor and an operation method for a nuclear reactor will be described in detail by referring to the accompanying drawings.

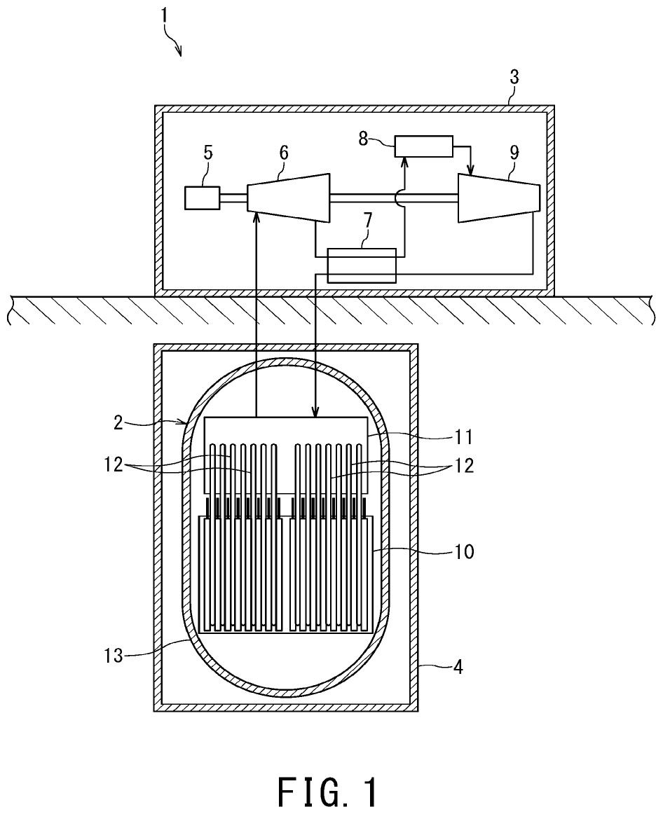

The reference sign 1 in FIG. 1 denotes a nuclear power generation system of the present embodiment. This nuclear power generation system 1 includes a small nuclear reactor 2.

The nuclear power generation system 1 includes an on-ground container 3 to be installed on the ground and an under-ground container 4 to be installed underground. These components can be loaded on a vehicle such as a trailer and can be transported to the installation site. In other words, the nuclear reactor 2 is configured as a transportable system and is also configured as, for example, a very small modular reactor (vSMR). Note that the nuclear power generation system 1 of the present invention is only one of various aspects. The shape and size of the nuclear reactor 2 are not limited to those of the present embodiment. The on-ground container 3 accommodates a generator 5, a gas turbine 6, a regenerative heat exchanger 7, a radiator 8, and a compressor 9. The under-ground container 4 accommodates the nuclear reactor 2. The nuclear reactor 2 includes a core 10, a heat exchanger 11, heat pipes 12, and a reactor vessel 13. The reactor vessel 13 is a metal container that houses the core 10, the heat exchanger 11, and the heat pipes 12.

The core 10 and the heat exchanger 11 are connected to each other by a plurality of heat pipes 12. The heat generated in the core 10 is conducted to the heat exchanger 11 via the heat pipes 12. This heat expands the working gas (refrigerant) and sends it to the gas turbine 6. The gas turbine 6 is rotated by the flow of this gas. The gas turbine 6 is connected to the generator 5 via a rotating shaft, and the rotating force of the gas turbine 6 causes the generator 5 to generate electricity.

The working gas having passed through the gas turbine 6 is sent to the radiator 8 through the regenerative heat exchanger 7. This radiator 8 releases the heat of gas into the air. The compressor 9 is connected to the gas turbine 6 via the rotating shaft, and compresses the working gas by using the rotating force of the gas turbine 6. The working gas is compressed into a high-temperature high-pressure semi-liquid state. This working gas is returned to the heat exchanger 11 of the nuclear reactor 2 through the regenerative heat exchanger 7. The nuclear power generation system 1 generates electric power by repeating the above-described cycle.

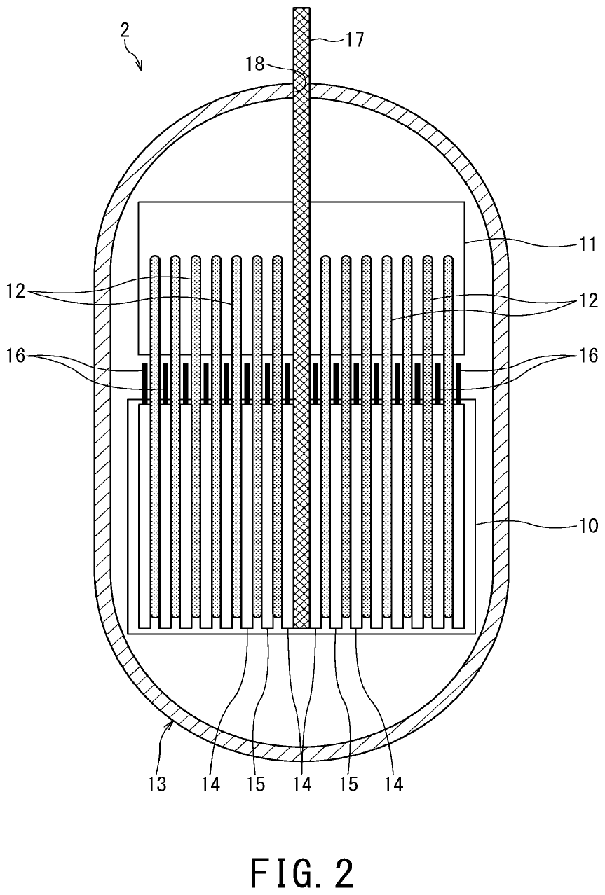

As shown in FIG. 2, inside the reactor vessel 13 of the nuclear reactor 2, a core 10 including nuclear fuels 14 and moderators 15 are provided. Each of the nuclear fuels 14 and the moderators 15 is a rod extending vertically. In the present embodiment, the plurality of nuclear fuels 14 and the plurality of moderators 15 are alternately arranged in the horizontal direction.

In FIG. 2, the configuration of core 10 is illustrated in a simplified manner in order to facilitate understanding. For example, some of the nuclear fuels 14 and some of the moderators 15 are omitted in FIG. 2.

The nuclear fuels 14 are members that generate energy by causing a fission chain reaction. The nuclear fuels 14 contain uranium as the main nuclear fuel material. The content of ²³⁵U in each nuclear fuel 14 has been increased from about 3% to 4% by concentrating natural uranium, for example. Further, the nuclear fuels 14 may include ²³⁹Pu. It is satisfactory if the nuclear fuels 14 contain sufficient amount of nuclear fuel material for operating at least the nuclear reactor 2.

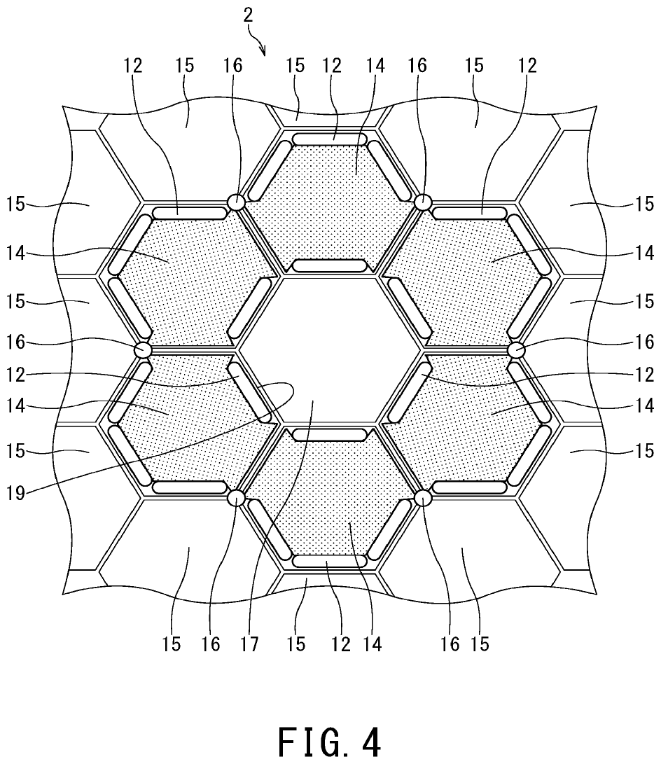

The moderators 15 are members that slow down neutrons. These moderators 15 are formed of metal hydrides such as calcium hydride. The moderators 15 may be formed of only metal hydride or may contain a substance other than metal hydride. Further, the moderators 15 may be formed of metal hydride excluding calcium hydride. The moderators 15 are formed as ceramics that are hard to thermally expand. The nuclear fuels 14 and the moderators 15 are hexagonal in cross-section (FIG. 4).

The core 10 has a cylindrical shape in which the plurality of nuclear fuels 14 and the plurality of moderators 15 are bundled. Note that the core 10 may be in the shape of a rectangular parallelepiped (cube) or a cone.

As shown in FIG. 2, each of the heat pipes (i.e., heat removal members) 12 is disposed between the adjacent nuclear fuel 14 and moderator 15, and extends from the core 10 to the heat exchanger 11.

The heat pipes 12 are devices that move heat by using a working fluid. For example, each of the heat pipes 12 includes: a pipe case made of a material with high thermal conductivity; a volatile working fluid enclosed in this pipe case; a cavity for moving the vaporized working fluid; and a wick that is provided on the inner wall of the pipe case so as to form a capillary structure.

Aluminium or copper is used as an example for the pipe and the wick. For example, liquid sodium is used for the working fluid. Alternative CFCs may be used for the working fluid. Further, another working fluid may be used instead.

When one end of each heat pipe 12 is defined as a high-temperature portion and the other end of each heat pipe 12 is defined as a low-temperature portion, heating the high-temperature portion and cooling the low-temperature portion generates a cycle of evaporation of the working fluid (i.e., absorption of latent heat) and condensation of the working fluid (release of latent heat), and thereby, heat is transferred.

For example, the liquid working fluid in the high-temperature portion evaporates by being heated, becomes a gas, and moves to the low-temperature portion through the cavity. Afterward, the heat of the working fluid is taken away in the low-temperature portion and the working fluid is condensed back into a liquid. Further, the liquid of the working fluid is moved to the high-temperature portion through the wick by the capillary phenomenon. This phenomenon is repeated, and thereby, heat is transferred from the high-temperature portion to the low-temperature portion.

In the present embodiment, the high-temperature portions of the respective heat pipes 12 are arranged in the core 10, and the low temperature portions of the respective heat pipes 12 linearly extending from the core 10 are arranged in the heat exchanger 11. The heat generated in the core 10 is transferred to the heat exchanger 11 by the heat pipes 12, and the working gas (refrigerant) is heated by this heat.

A plurality of control devices 16 can be inserted into the core 10 as neutron absorbers that control fission reaction (FIG. 4). The fission reaction is suppressed by inserting these control devices 16 into the core 10, and the fission reaction becomes active by pulling out the control devices 16 from core 10. Each of the control devices 16 may be rod-shaped or plate-shaped. The reactor vessel 13 may be configured to serve also as a neutron reflector that reflects neutrons to be emitted from the nuclear fuels 14.

The core 10 is configured such that one absorber rod 17 as a neutron absorber can be inserted into the center of core 10. This absorber rod 17 is a member to be inserted before start-up of the nuclear reactor 2 such that the nuclear fuels 14 do not cause a fission reaction. For example, when the nuclear reactor 2 is transported to the installation site, the nuclear reactor 2 is kept in the state in which the absorber rod 17 is inserted into the core 10. At the time of start-up of the nuclear reactor 2, the absorber rod 17 is pulled out from the core 10.

At the upper portion of the reactor vessel 13, an insertion section (i.e., hole) 18, through which the absorber rod 17 can be inserted into the inside of the core 10, is opened. After pulling out the absorber rod 17, the insertion section 18 is closed with a predetermined lid.

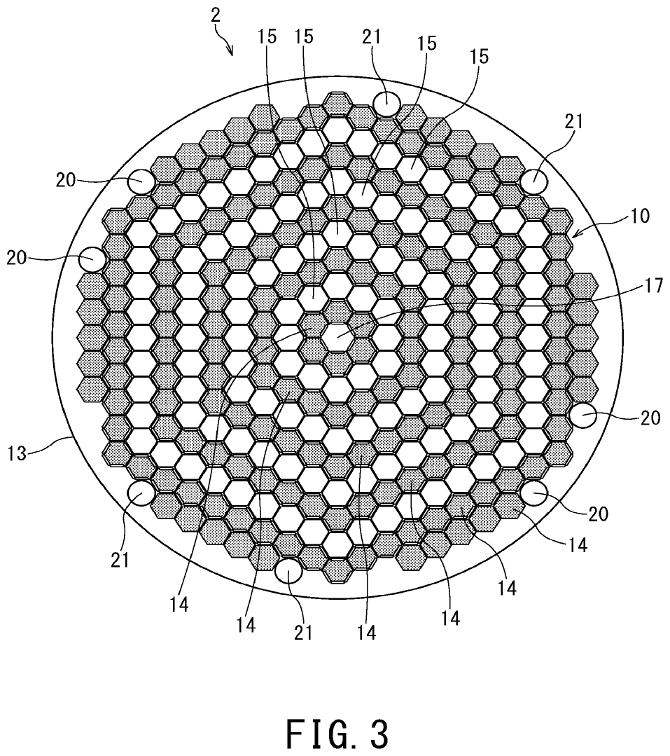

Next, the structure of the core 10 will be described by referring to FIG. 3 and FIG. 4. Although FIG. 3 and FIG. 4 are cross-sectional views, hatching is omitted in order to facilitate understanding.

At the center portion of the core 10, an insertion space 19 is provided and the absorber rod 17 is inserted into this insertion space 19. Some of the nuclear fuels 14 are annularly arranged so as to surround the insertion space 19. Some of the moderators 15 are annularly arranged so as to surround these nuclear fuels 14. Some of the nuclear fuels 14 are annularly arranged so as to surround these moderators 15. In this manner, annular rows of nuclear fuels 14 and annular rows of moderators 15 are arranged alternately in the radial direction of the core 10. In other words, the annular rows of nuclear fuels 14 and the annular rows of moderators 15 are concentrically and alternately arranged.

Each of the heat pipes 12 has a flat plate shape in cross-section. The side surfaces of each of the nuclear fuels 14 are cut out, and the heat pipes 12 are arranged close to these nuclear fuels 14.

There is a gap between each nuclear fuel 14 and each moderator 15. The nuclear fuels 14 and the heat pipes 12 have portions that are in contact with each other, and also have portions that have a slight gap between both.

Such gaps are filled with a heat transfer liquid as a liquid metal that reduces contact thermal resistance. The heat transfer liquid of the present embodiment is composed of a substance, which is solid at room temperature and is melted into a liquid at an operating temperature (i.e., a specific temperature) after the startup of the nuclear reactor 2. That is, the heat transfer liquid is composed of the substance, melting point of which is higher than the room temperature and lower than the operating temperature of the nuclear reactor 2.

The heat transfer liquid may be any substance as long as it is a solid at room temperature and becomes a liquid at the operating temperature of the nuclear reactor 2. For example, the heat transfer liquid may be a metal such as aluminum, gallium, sodium, lithium, lead, and bismuth or may be an alloy containing these.

For example, when the nuclear reactor 2 is manufactured, a metal foil in which the heat transfer liquid is solidified is provided in each of the gaps between the nuclear fuels 14 and the moderators 15. After the nuclear reactor 2 is started, the temperature of the core 10 is raised from the normal temperature to the operating temperature, and thereby, these metal foils are melted and become a heat transfer liquid. Consequently, the heat transfer liquid is filled in each of the gaps between the nuclear fuels 14 and the heat pipes 12.

In this manner, the heat transfer liquid fills the gaps between the nuclear fuels 14 and the heat pipes 12 (other members), and thus, the contact thermal resistance can be reduced. Hence, the heat transfer efficiency from the nuclear fuels 14 to the heat pipes 12 is improved. Further, even if the nuclear fuels 14 and other members expand due to the temperature rise of the core 10 after startup, the core 10 can be prevented from being damaged due to the existence of the gaps and the fact that the metal filled in each gap is a liquid.

In the present embodiment, the nuclear reactor 2 can be readily operated by providing the heat transfer liquid in the form of a metal foil the core 10 during manufacturing. For example, in the case of the small transportable nuclear reactor 2, it is difficult to keep the heat transfer liquid in a liquid state because the nuclear reactor 2 is stopped and is in a low temperature state during transportation. For this reason, the nuclear reactor 2 is transported under the state where the heat transfer liquid is in a solid state (i.e., metal foil), and the heat transfer liquid is changed into liquid after starting the nuclear reactor 2.

Inside the core 10, electromagnetic pumps 20 that circulate the heat transfer liquid as a liquid metal are attached. With this configuration, the heat transfer liquid is circulated by the electromagnetic pumps 20 during operation, and the temperature difference inside the nuclear reactor 2 can be efficiently reduced.

Inside the core 10, a plurality of core-heating heaters 21 in the shape of a rod extending in the vertical direction are installed close to the nuclear fuels 14. These core-heating heaters 21 are used to heat the nuclear fuels 14 at the time of start-up of the nuclear reactor 2. The core-heating heaters 21 may be configured to generate Joule heat by electric resistance for performing heating or may be configured to use another heating method.

The electromagnetic pumps 20 and the core-heating heaters 21 may be provided side by side in the horizontal direction or may be provided side by side in the vertical direction. Such an arrangement can promote the uniformization of the temperature difference inside the core 10 when the nuclear reactor 2 is started.

Europium (Eu) is added to the nuclear fuels 14 of the present embodiment as an additive to the main nuclear fuel material. Even if all the control devices 16 are pulled out before starting the nuclear reactor 2, the above-described composition of the nuclear fuels 14 enables the nuclear reactor 2 to be kept in the subcritical state.

For example, even in the case where all the control devices 16 are pulled out, if the core 10 remains in the subcritical state, a criticality accident does not occur and the nuclear reactor 2 can be transported safely. In order to operate the nuclear reactor 2, it is necessary to put the core 10 into a critical state, so it is necessary to apply a positive reactivity to the core 10 by some means. It is preferred that the application of the positive reactivity is achieved without using dynamic equipment for reliability and simplification of devices.

In the present embodiment, the nuclear reactor 2 includes: the moderators 15 containing calcium hydride as a metal hydride; and the nuclear fuels 14 to which europium is added. The positive reactivity of the core 10 in the low temperature range is utilized, and thereby, the subcriticality is secured in the low temperature state and the reactivity is applied by forcibly heating the core 10.

This nuclear reactor 2 has a subcritical and a positive temperature reactivity coefficient at low temperature (i.e., normal temperature), and has a critical and a negative temperature reactivity coefficient at high temperature (i.e., operating temperature). When the absorber rod 17 is inserted, the nuclear reactor 2 does not reach the criticality even in a high temperature state, so that the criticality safety can be ensured during transportation and installation of the nuclear reactor.

Next, the principle of the nuclear reactor 2 of the present embodiment will be described. This nuclear reactor 2 is based on a new principle found by the present inventors.

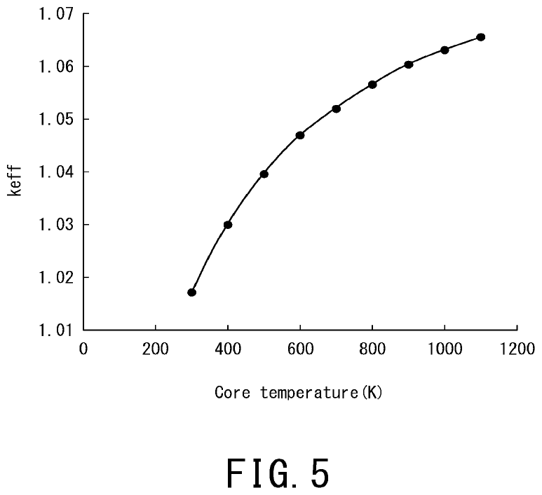

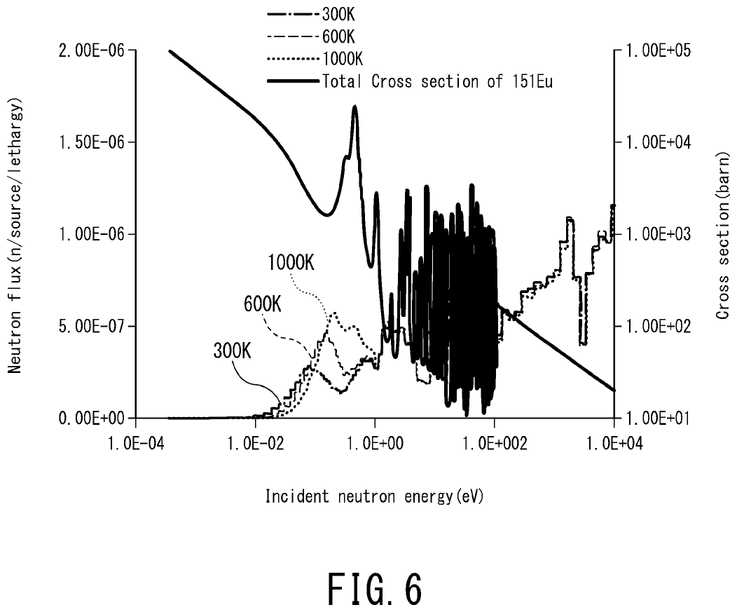

For example, as shown in the graph of FIG. 5, it can be seen that the temperature-dependent effective core multiplication factor increases with temperature. The neutron spectrum shift changes as the temperature changes from 300K to 1000K, as shown in the graph of FIG. 6. The increase in the temperature-dependent effective core multiplication factor is ascribable to the neutron spectrum shift in association with this temperature rise. Control of this temperature reactivity is achieved by adding ¹⁵¹Eu and ¹¹³Cd having a resonance structure, which increase neutron absorption amount after the neutron spectrum shift in association with temperature rise, to the core. This is disclosed in Non-Patent Document 1, which is the paper of the present inventors.

The inventors have conducted further research and have obtained the following novel findings. When only ¹⁵¹Eu that controls the temperature reactivity at high temperature (i.e., operating temperature range) is used as an additive to the nuclear fuels 14, the core 10 can be configured to have the positive temperature reactivity in the low-temperature range below the operating temperature and have the negative temperature reactivity in the high-temperature range above the operating temperature.

The additive is europium having a natural composition. In this manner, a low-cost additive can be used. Concentrated products of ¹⁵¹Eu are generally expensive and unlikely to be used in commercial furnaces, and thus, europium of natural composition is used in the present embodiment.

The additive may be europium that is more enriched in the concentration of its isotope ¹⁵¹Eu than europium of natural composition. In this manner, in controlling the critical state of the nuclear reactor 2, a larger effect can be obtained than the case of using europium of natural composition. Since various values can be considered as the enrichment of ¹⁵¹Eu, the enrichment is not limited to a specific value.

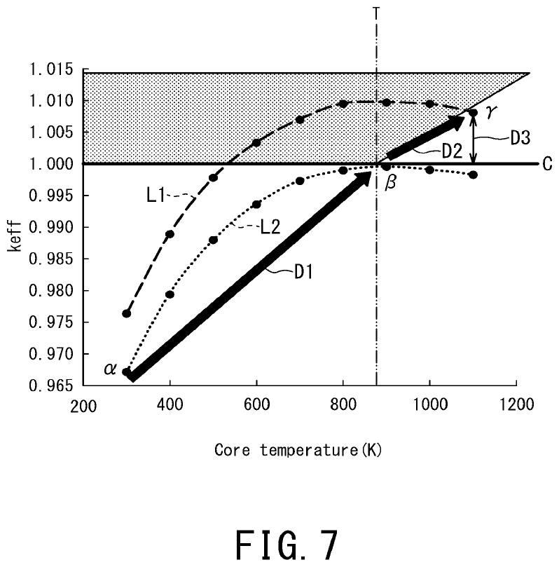

The graph of FIG. 7 shows the temperature-dependent effective core multiplication factor of the nuclear reactor 2 having the nuclear fuels 14 in which europium (Eu) of natural composition is added. In the graph of FIG. 7, the line L1 shows the temperature-dependent effective core multiplication factor under the state where the absorber rod 17 is pulled out. The line L2 shows the temperature-dependent effective core multiplication factor under the state where the absorber rod 17 is inserted into the nuclear reactor 2. When the lines L1 and L2 rise to the right, indicates that the nuclear reactor 2 has the positive temperature reactivity. When the lines L1 and L2 fall to the right, it indicates that the nuclear reactor 2 has the negative temperature reactivity.

As shown in this graph, the core 10 of the present embodiment has the positive temperature reactivity from about 300K to 800K regardless of whether the absorber rod 17 is inserted or not. At temperatures above 800 K, it is clear from the graph that the core effective multiplication factor decreases and the core 10 has the negative temperature reactivity.

In the inserted state of the absorber rod 17, the core 10 cannot exceed the critical value C over the entire temperature range, resulting in the subcritical state. Even in the state where the absorber rod 17 is pulled out, the subcritical state can be maintained until the temperature of the core 10 reaches about 500K. In other words, even under the state where the neutron absorbing material such as the absorber rod 17 and the control devices 16 is not inserted into the core 10, in an environment where the core temperature is not expected to reach a high temperature of 500K or higher, the core 10 cannot become the critical state. Accordingly, during the transportation or installation work of the nuclear reactor 2, the nuclear reactor 2 does not become the critical state and the criticality safety can be secured.

In a general nuclear reactor, the core effective multiplication factor under the state where the control devices are pulled out is lower at high temperature, so it is designed to have a higher surplus reactivity at a low temperature range. The present embodiment can provide the nuclear reactor 2 that is subcritical in a low temperature range and cannot cause a criticality accident in principle.

At the time of start-up of the nuclear reactor 2, the core 10 is forcibly heated by the core-heating heaters 21. Further, the temperature of the core 10 is made higher than the specific temperature T specified in advance so that the nuclear reactor 2 can be started.

In the graph of FIG. 7, the state of the core 10 during transportation or before start-up of the nuclear reactor 2 is the state at the position α, i.e., the subcritical state at low temperature. From this state, the core 10 is forcibly heated by the core-heating heaters 21 with the absorber rod 17 inserted, and the core 10 shifts to the state of the position β. The arrow D1 in this graph indicates application of reactivity by forced heating with the use of the core-heating heaters 21.

Although the core 10 is in the subcritical state at the position β, the nuclear reactor 2 reaches criticality by gradually pulling out the absorber rod 17 from this state. From this state, the absorber rod 17 is further pulled out, and the core 10 shifts to a steady state by a mechanism that performs normal reactivity control. The arrow D2 in this graph indicates the application of reactivity by pulling out the absorber rod 17.

In this state, the effective core multiplication factor excluding the effect of the mechanism for controlling the normal temperature reactivity changes from the position β to the position γ. However, at the position of β, the temperature reactivity coefficient of the core 10 switches to a negative value, and after pulling out the absorber rod 17, the nuclear reactor 2 can be controlled while maintaining its self-controllability. The arrow D3 in this graph indicates the excess reactivity to be controlled by the control devices 16. The halftone dot area of the graph indicates an area that is not used for operating the nuclear reactor 2.

In the present embodiment, the temperature at the position β is specified in advance when the nuclear reactor 2 is designed, and this temperature is set as the specific temperature T. The specific temperature T may be a value included in the operating temperature range or a temperature lower than the operating temperature.

The addition amount of europium as an additive to the nuclear fuel material is in the range of 0.02 at % to 0.50 at %. Since the addition amount of the additive is 0.02 at % or more, the effect of keeping the subcritical state before start-up of the nuclear reactor 2 can be sufficiently obtained. Since the addition amount of the additive is 0.50 at % or less, the output of the nuclear reactor 2 is not affected.

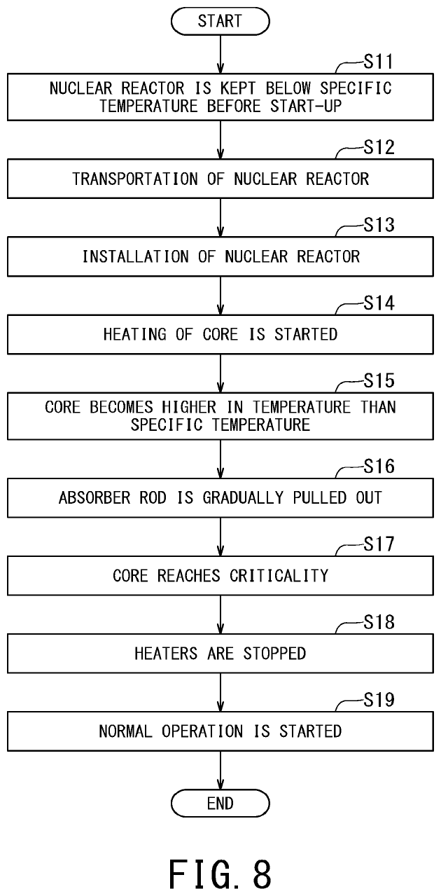

Next, a description will be given of an operation method for the nuclear reactor 2 including the action passively generated by the operation of this nuclear reactor 2 by referring to the flowchart of FIG. 8.

First, in the step S11, the nuclear reactor 2 is kept below the specific temperature T before start-up. In the environment where the nuclear reactor 2 is kept at room temperature, it usually does not rise above the specific temperature T.

In the next step S12, the nuclear reactor 2 is transported to the designated installation site. Normally, the nuclear reactor 2 is kept at room temperature during transportation, so the temperature of the core 10 does not exceed the specific temperature T. Thus, the nuclear reactor 2 can be safely transported.

In the next step S13, construction is performed to install the nuclear reactor 2 at the specified installation site. Also in this step, the core 10 never reaches criticality, so the installation work can be performed safely.

In the next step S14, at the time of start-up of the nuclear reactor 2, the core-heating heaters 21 are activated and heating of the core 10 is started.

In the next step S15, the core 10 becomes higher in temperature than the specific temperature T due to the heating by the core-heating heaters 21.

In the next step S16, under the state where the nuclear reactor 2 at a temperature higher than the specific temperature T, the absorber rod 17 is gradually pulled out from the core 10, and thereby, a positive reactivity is applied. Here, control by the control devices 16 is started.

In the next step S17, the core 10 reaches criticality. Here, the absorber rod 17 is completely pulled out from the core 10, and the control of the core 10 is switched to the control by only the control devices 16.

In the next step S18, the core-heating heaters 21 are stopped. The core-heating heaters 21 may be stopped before the core 10 reaches criticality.

In the next step S19, a normal operation of the nuclear reactor 2 is started.

Although a mode in which each step is executed in series is illustrated in the flowcharts of the present embodiment, the execution order of the respective steps is not necessarily fixed and the execution order of part of the steps may be changed. Additionally, some steps may be executed in parallel with another step.

In the present embodiment, as shown in FIG. 3, the core-heating heaters 21 for heating the nuclear fuels 14 are attached inside the reactor vessel 13 in advance. In this manner, the core 10 can be brought into the critical state by heating the nuclear fuels 14 with the core-heating heaters 21 at the time of start-up. In other words, before starting the nuclear reactor 2, the core 10 can be controlled so as to have the positive temperature reactivity coefficient.

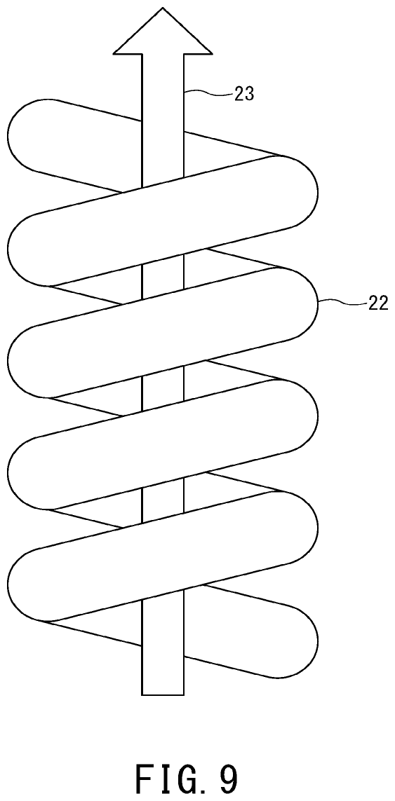

Next, modifications of the core-heating heaters 21 will be described by referring to FIG. 9 to FIG. 11.

As shown in FIG. 9, the configuration of the first modification includes an induction heater 22 that heats a metal by electromagnetic induction. The induction heater 22 is a device that performs induction heating by using a coil. In this configuration, the nuclear reactor 2 can be efficiently heated.

The induction heater 22 is submerged in a heat transfer liquid 23 as a liquid metal for reducing contact thermal resistance. When the induction heater 22 is driven, the heat transfer liquid 23 flows along the axial direction inside the coil, and thereby, the heat transfer liquid 23 is naturally circulated. Since such an induction heater 22 is used, the flow path of the heat transfer liquid 23 can be widened. When the nuclear reactor 2 is forcibly heated at the time of startup, the temperature difference inside the core 10 can be reduced early.

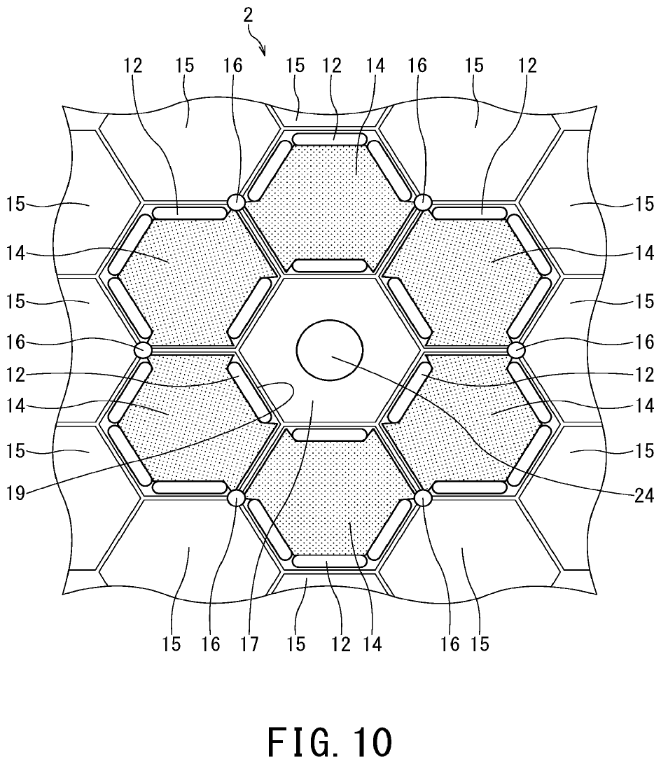

As shown in FIG. 10, in the second modification, a core-heating heater 24 is provided in the central portion of the absorber rod 17. That is, the absorber rod 17 and the core-heating heater 24 are integrated. For example, the absorber rod 17 is formed in a hollow shape, and the core-heating heater 24 is provided inside the absorber rod 17. In such a configuration, the core-heating heater 24 is provided in the central portion of the core 10, and thus, the nuclear reactor 2 can be efficiently heated from the center.

The shape of the core-heating heater 24 is not limited to a specific shape as long as it can be inserted into the absorber rod 17 and various shapes are conceivable.

The neutron absorber in the central portion of the absorber rod 17 has little value for the reactivity of the core 10 and has no influence on the characteristics of the core 10. That is, the central portion of the absorber rod 17 is a dead space, and the core-heating heater 24 is provided in this dead space. In addition, wiring related to the core-heating heater 24 can be installed together with the driving device for the absorber rod 17. Thus, the internal space of the reactor vessel 13 can be effectively used.

After start-up of the nuclear reactor, the core-heating heater 24 is not used and becomes unnecessary, and this core-heating heater 24 can be removed from the nuclear reactor 2 together with the absorber rod 17. When the nuclear reactor 2 is stopped, the core-heating heater 24 can be inserted into the reactor vessel 13 by inserting the absorber rod 17 again from the insertion section 18 of the reactor vessel 13. That is, the absorber rod 17 and the core-heating heater 24 can be put into and taken out of the reactor vessel 13 at the same time.

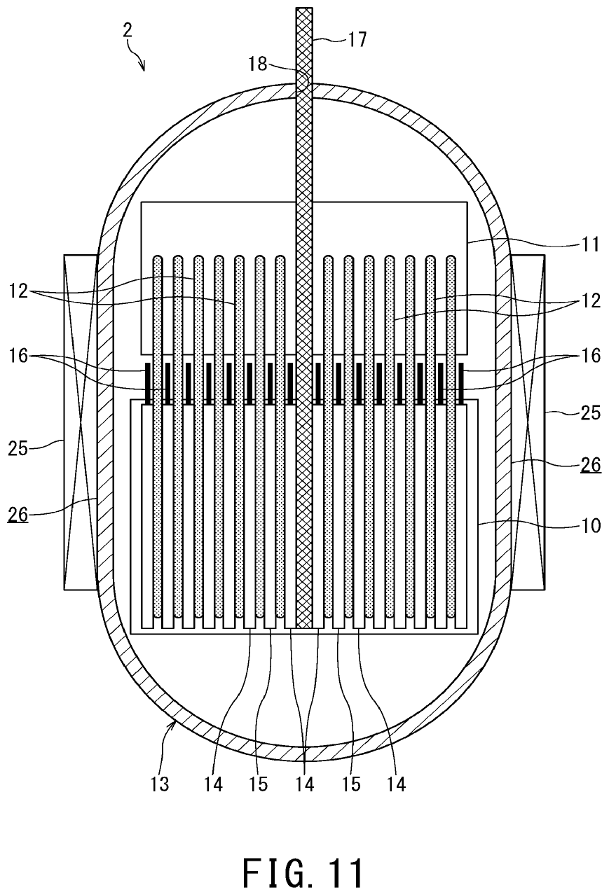

As shown in FIG. 11, in the third modification, a core-heating heater 25 is detachably attached to the outer surface of the reactor vessel 13. That is, the outer surface of the reactor vessel 13 serves as a mounting portion 26 to which the core-heating heater 25 can be mounted. In this configuration, the core-heating heater 25 can be readily attached to and detached from the reactor vessel 13.

The core-heating heater 25 may be an induction heater. The core-heating heater 25 may be configured to heat the metal forming the reactor vessel 13 by electromagnetic induction. That is, induction heating may be performed by using the entire reactor vessel 13 as a core. In this manner, the entire reactor vessel 13 generates heat, so heating can be performed more efficiently than simply heating from outside.

Further, the metal to be heated by the core-heating heater 25 can also be used as the reactor vessel 13. Moreover, it is not necessary to install the core-heating heater 25 inside the reactor vessel 13, and thus, the internal structure of the reactor vessel 13 can be simplified. Furthermore, the core-heating heater 25 removed from the reactor vessel 13 can be reused for starting another nuclear reactor 2.

Although europium is added to the nuclear fuels 14 in the above-described embodiments including the modifications such that the nuclear reactor 2 obtains a characteristic of keeping the subcritical state even under the state where all the control devices are pulled out before start-up, other aspects may be adopted for obtaining the same characteristic. For example, even when europium is not added to the nuclear fuels 14, the same characteristic as in the above-described embodiments can be obtained depending on the fuel enrichment or the geometrical shape of the core 10.

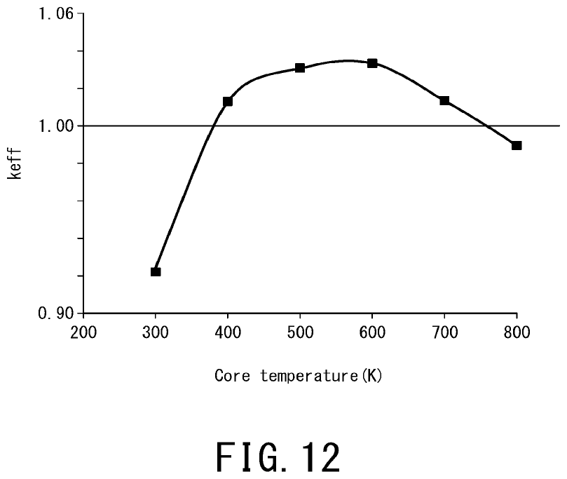

For example, as shown in the graph of FIG. 12 illustrating the fourth modification, fuel enrichment or geometrical shape of the core 10 may be appropriately changed such that the temperature-dependent effective core multiplication factor increases with temperature rise in the low-temperature range and begins to decrease with increasing temperature in the high temperature range. That is, the fuel enrichment or the geometrical shape of the core 10 may be appropriately changed such that the graph of the temperature-dependent effective core multiplication factor has an inverted U shape.

Although the core-heating heaters 21 are used to heat the nuclear fuels 14 in the above-described embodiments, other aspects may be adopted for heating the nuclear fuels 14. For example, if there is a heat source other than the core-heating heaters 21, the core-heating heaters 21 may not be used.

Although the heat pipes 12 are used to cool the core 10 in the above-described embodiments, various cooling methods for the core 10 are conceivable and the cooling methods are not limited to the heat pipes 12.

Although the heat pipes 12 in which the working fluid is enclosed are exemplified as the devices for moving the heat from the core 10 in the above-described embodiments, a heat pipe (heat remover) 12 of another aspect may be used instead. For example, a solid heat pipe having no cavity inside may be used. Further, heat may be transferred from the core by using a heat-pump-type heat removal device.

According to the above-described embodiments, the nuclear reactor includes: a moderator containing a metal hydride; and a nuclear fuel in which europium is added as an additive to its main nuclear fuel material, and thus, the nuclear reactor can be kept in the subcritical state even under the state where all the control devices are pulled out before startup.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nuclear reactor comprising:
a moderator including a metal hydride; and
a nuclear fuel in which europium is added as an additive to a main nuclear fuel material.

2. The nuclear reactor according to claim 1, wherein the additive is europium of natural composition.

3. The nuclear reactor according to claim 1, wherein the additive is europium that is more enriched in concentration of ¹⁵¹Eu than europium of natural composition.

4. The nuclear reactor according to claim 1, further comprising a reactor vessel configured to accommodate the nuclear fuel,
wherein the reactor vessel is configured in such a manner that a core-heating heater for heating the nuclear fuel can be attached to the reactor vessel.

5. The nuclear reactor according to claim 4, wherein the reactor vessel includes an insertion section through which the core-heating heater can be inserted.

6. The nuclear reactor according to claim 5, wherein:
the insertion section is configured in such a manner that an absorber rod can be inserted through the insertion section; and
the absorber rod is provided with the core-heating heater.

7. The nuclear reactor according to claim 4, wherein an outer surface of the reactor vessel is provided with a mounting portion to which the core-heating heater can be mounted.

8. The nuclear reactor according to claim 4, wherein the core-heating heater is an induction heater that heats metal by electromagnetic induction.

9. The nuclear reactor according to claim 8, wherein the induction heater is configured to heat metal forming the reactor vessel by electromagnetic induction.

10. The nuclear reactor according to claim 1, further comprising an electromagnetic pump configured to circulate a liquid metal that reduces contact thermal resistance between the nuclear fuel and other member.

11. The nuclear reactor according to claim 1, wherein addition amount of the additive is in a range of 0.02 at % to 0.50 at %.

12. An operation method for a nuclear reactor that includes: a moderator including a metal hydride; and a nuclear fuel in which europium is added as an additive to a main nuclear fuel material, the operation method comprising a step of maintaining the nuclear reactor lower in temperature than a specific temperature before start-up of the nuclear reactor.

13. The operation method for a nuclear reactor according to claim 12, further comprising a step of heating the nuclear reactor at a time of the start-up of the nuclear reactor in such a manner that temperature of the nuclear reactor becomes higher than the specific temperature.

14. The operation method for a nuclear reactor according to claim 13, further comprising a step of applying a positive reactivity by pulling out an absorber rod under a state in which temperature of the nuclear reactor is higher than the specific temperature.
